(19) United States
(12) Patent Application Publication
(10) Pub. No.: US 2025/0360848 A1
(43) Pub. Date: Nov. 27, 2025

(54) INFANT CARRIER

(71) Applicant: WONDERLAND SWIZERLAND AG, Steinhausen (CH)

(72) Inventors: Kun ZHANG, Dongguan (CN); Xiaolong Mo, Dongguan (CN)

(21) Appl. No.: 19/181,887

(22) Filed: Apr. 17, 2025

(30) Foreign Application Priority Data
Apr. 19, 2024 (CN) 202410483347.X

(51) Int. Cl. B60N 2/28; A47D 13/02

(52) U.S. Cl. CPC B60N 2/2845; A47D 13/027

(57) ABSTRACT

The present disclosure provides an infant carrier, including: a carrier body; an anchor, the anchor being pivotally connected to the carrier body and configured to pivot between a folded position and an unfolded position, wherein one of the carrier body and the anchor is provided with an engagement portion, and the other one of the carrier body and the anchor is provided with a position limiting portion, and when the anchor is pivoted to the folded position, the engagement portion is engaged with the position limiting portion, the position limiting portion is a position limiting slot, the engagement portion includes an engagement pin and an engagement spring, the engagement pin is configured to protrude from or retract into the one of the carrier body and the anchor, and the engagement spring tends to make the engagement pin protrude from the one of the carrier body and the anchor.

### CROSS-REFERENCE TO RELATED APPLICATIONS

This application claims priority to Chinese Application No. 202410483347.X, entitled “INFANT CARRIER” and filed on Apr. 19, 2024, which is incorporated herein by reference in its entirety.

### TECHNICAL FIELD

The present disclosure relates to an infant carrier.

### BACKGROUND

An infant carrier is a portable safety sleep and transport device specifically designed for newborns and infants. It typically features a basket-like structure equipped with comfortable padding and handles, used to carry and protect infants during short indoor naps, outings, or travel in vehicles. Traditional infant carriers are often installed on vehicle seats by using a vehicle safety seat base, where the safety seat is detachably mounted onto the seat base. The seat base may be installed on the vehicle seat by using seat belts attached to the seat base and/or a pair of anchors. Once the seat base is installed on the vehicle seat, the infant carrier may be detachably connected to the seat base.

At present, some infant carriers are also equipped with anchors on the carrier body. However, existing infant carriers are not convenient for storing the anchors, which negatively impacts the user's operational experience.

### SUMMARY

According to an aspect of the present disclosure, there is provided an infant carrier, including: a carrier body; an anchor for connecting to a vehicle seat, the anchor being pivotally connected to the carrier body and configured to pivot between a folded position and an unfolded position, wherein one of the carrier body and the anchor is provided with an engagement portion, and the other one of the carrier body and the anchor is provided with a position limiting portion, and when the anchor is pivoted to the folded position, the engagement portion is engaged with the position limiting portion to restrict the anchor in the folded position, wherein the position limiting portion is a position limiting slot, the engagement portion includes an engagement pin and an engagement spring, the engagement pin is configured to protrude from or retract into the one of the carrier body and the anchor, and the engagement spring tends to make the engagement pin protrude from the one of the carrier body and the anchor to engage with the position limiting slot.

In one embodiment, an engagement end of the engagement pin that engages with the position limiting slot is tapered, and an opening edge of the position limiting slot is provided with a first guiding slope, so that the engagement pin is disengaged from the position limiting slot when the anchor is driven to pivot.

In one embodiment, the engagement end of the engagement pin that engages with the position limiting slot is tapered, and an edge of the other one of the carrier body and the anchor that contacts the engagement pin is provided with a second guiding slope, so that the engagement pin retracts into the one of the carrier body and the anchor when the anchor is driven to pivot toward the folded position.

In one embodiment, the anchor includes a straight anchor connecting joint at its free end and a curved anchor connecting portion at its pivot end, the anchor connecting joint is configured to connect with the vehicle seat, and the anchor connecting portion is pivotally connected with the carrier body and curved toward the folded position, wherein the position limiting slot or the engagement pin is provided on the anchor connecting portion.

In one embodiment, the carrier body is provided with a receiving groove, and the anchor pivoted to the folded position is configured to be accommodated in the receiving groove, wherein the position limiting slot is provided on a side of the receiving groove facing the anchor, and the engagement pin is provided on a side of the anchor facing the receiving groove.

In one embodiment, the infant carrier includes two anchors, the two anchors are connected via a connecting rod, and the connecting rod is provided with a connecting rod gear, the carrier body is provided with a support device, the support device includes a pivotable support rod and a support rod gear fixedly connected to a pivot end of the support rod, wherein the support rod gear meshes with the connecting rod gear so that the pivot direction of the support rod is opposite to that of the anchor; when the anchor is in the folded position, the support rod is located on one side of a vertical line passing through a pivot axis of the support rod; and when the anchor is in the unfolded position, the support rod is located on the other side of the vertical line.

In one embodiment, the engagement pin is provided on the anchor, and the position limiting slot and the second guiding slope are provided on the carrier body; the anchor is configured such that when the anchor is in the unfolded position, the engagement pin abuts against the second guiding slope to prevent the anchor from pivoting toward the folded position.

The present disclosure has beneficial effects in that the infant carrier according to the present disclosure not only facilitates the unlocking of the anchor but also ensures reliable position limitation of the anchor, making it less prone to loosening.

The foregoing and other objectives, features, aspects, and advantages of the present disclosure will become more apparent from following detailed description of the present disclosure in conjunction with the drawings.

### BRIEF DESCRIPTION OF THE DRAWINGS

The drawings are included herein to provide a further understanding of the present disclosure and are incorporated into and constitute a part of this specification. The drawings illustrate embodiments of the present disclosure, and serve to explain the principles of the present disclosure together with the following description.

In the drawings:

FIG. 1 is a perspective view of an infant carrier according to a first embodiment of the present disclosure.

FIG. 2 is a side view of the infant carrier according to the first embodiment of the present disclosure, wherein the anchor is in a folded position.

FIG. 3 is a cross-sectional view taken along a line A-A in FIG. 2 and a partial enlarged view thereof.

FIG. 4 is another side view of the infant carrier according to the first embodiment of the present disclosure, wherein the anchor is in an unfolded position.

FIG. 5 is a cross-sectional view taken along a line B-B in FIG. 4 and a partial enlarged view thereof.

FIG. 6 is yet another side view of the infant carrier according to the first embodiment of the present disclosure, wherein the anchor is in an unfolded position.

FIG. 7 is a cross-sectional view taken along a line C-C in FIG. 6 and a partial enlarged view thereof.

FIG. 8 is a perspective view of an anchor and a connecting rod according to the first embodiment of the present disclosure.

FIG. 9 is a partially exploded perspective view of the anchor and connecting rod according to the first embodiment of the present disclosure.

FIG. 10 is a partially exploded perspective view of an infant carrier according to a second embodiment of the present disclosure.

FIG. 11 is a schematic view showing pivot positions of an anchor of the infant carrier according to the second embodiment of the present disclosure.

Reference numbers are listed as follows:
1 infant carrier
100 carrier body
110 position limiting portion, position limiting slot
111 first guiding slope
120 second guiding slope
130 receiving groove
200 anchor
200A anchor connecting joint
200B anchor connecting portion
201 anchor outer shell
202 anchor inner shell
203 inner shell opening
210 engagement portion
220 engagement pin
221 engagement end
230 engagement spring
240 position limiting ring
300 connecting rod
310 connecting rod gear
400 support rod
401 pivot end
410 support rod gear
420 gearbox
L vertical line passing through a pivot axis of a support rod
M vehicle seat surface

### DETAILED DESCRIPTION

Hereinafter, exemplary embodiments will be described in detail with reference to the accompanying drawings. Although various modifications and alternative forms may be made to the present disclosure, specific embodiments are shown by way of examples in the drawings. However, the present disclosure should not be construed as limiting embodiments set forth herein. Instead, the present disclosure is intended to cover all modifications, equivalents, and alternatives falling within the spirit and scope of the embodiments.

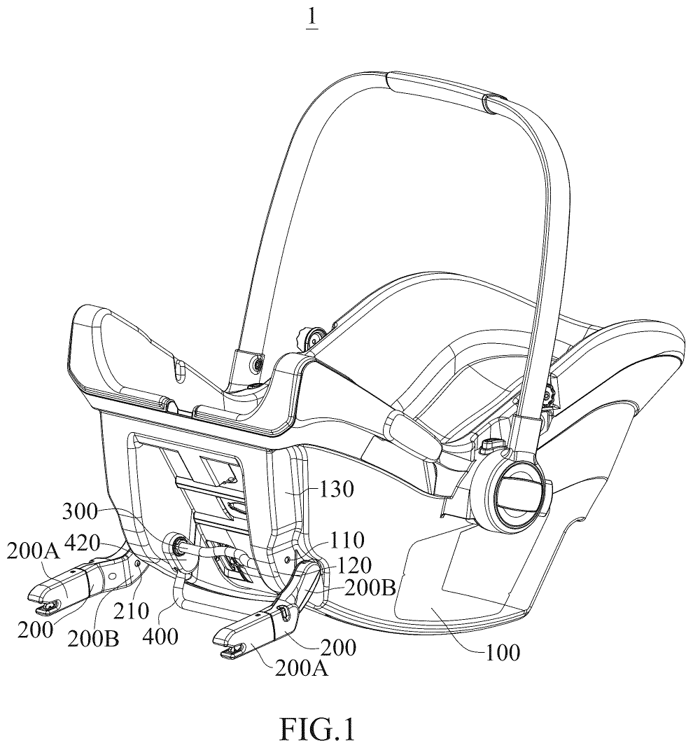

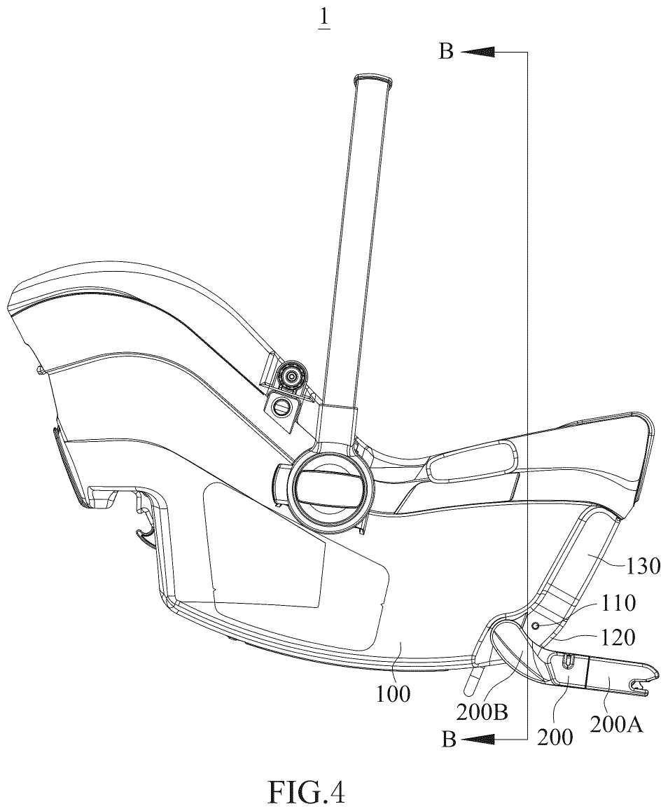

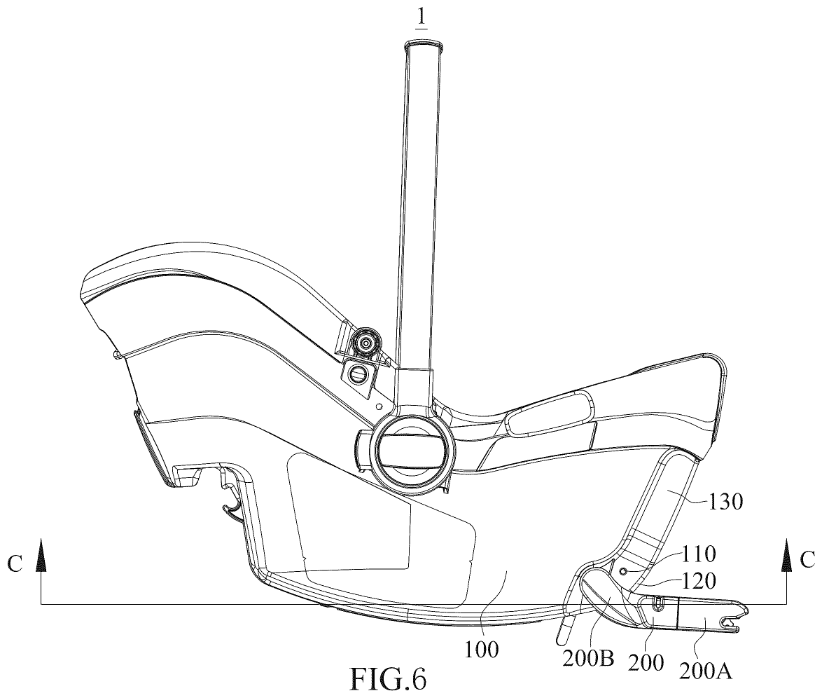

FIGS. 1 to 7 show an infant carrier 1 according to a first embodiment of the present disclosure. The infant carrier 1 includes a carrier body 100 and an anchor 200. The anchor 200 is pivotally connected to an end of the carrier body 100 corresponding to an infant's feet and may pivot relative to the carrier body 100. The anchor 200 is configured to connect the infant carrier 1 to a vehicle seat (not shown). Specifically, an engagement port of the anchor 200 may engage with anchor points on the vehicle seat, such as connecting rods, connecting rings, or anchor interfaces, so that the connection of the infant carrier 1 to the vehicle seat is more convenient and the structure is simpler. For example, the anchor 200 may be an ISOFIX connector.

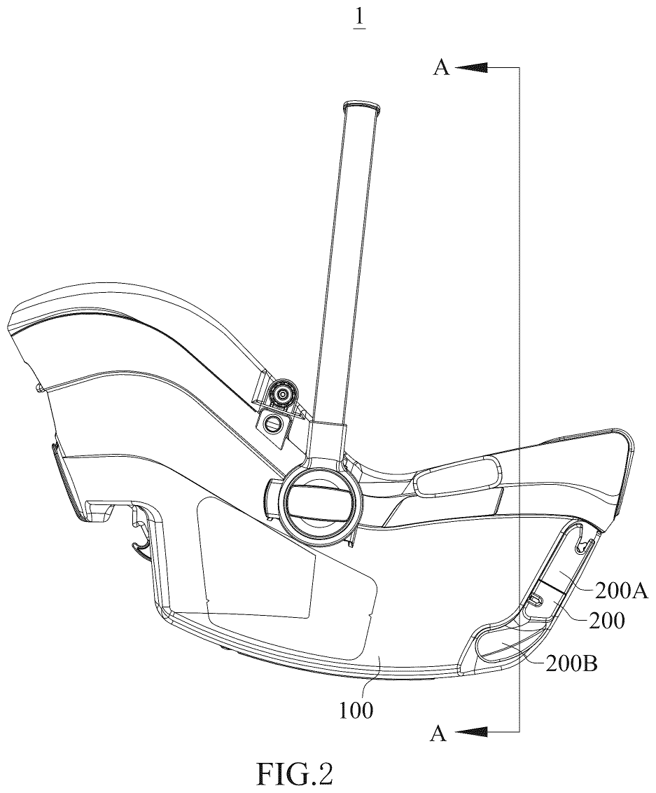

In order to enable the infant carrier 1 to be connected to different vehicles, the anchor 200 is configured to pivot between a folded position (see FIG. 2) and an unfolded position (see FIG. 1) relative to the carrier body 100.

When it is not necessary to connect the infant carrier 1 to the vehicle seat, a user may pivot the anchor 200 to the folded position to reduce its protrusion from the carrier body 100, making it easy to carry and move the infant carrier 1.

When it is necessary to connect the infant carrier 1 to the vehicle seat, the user may pivot the anchor 200 to the unfolded position to engage with the corresponding fittings on the vehicle seat.

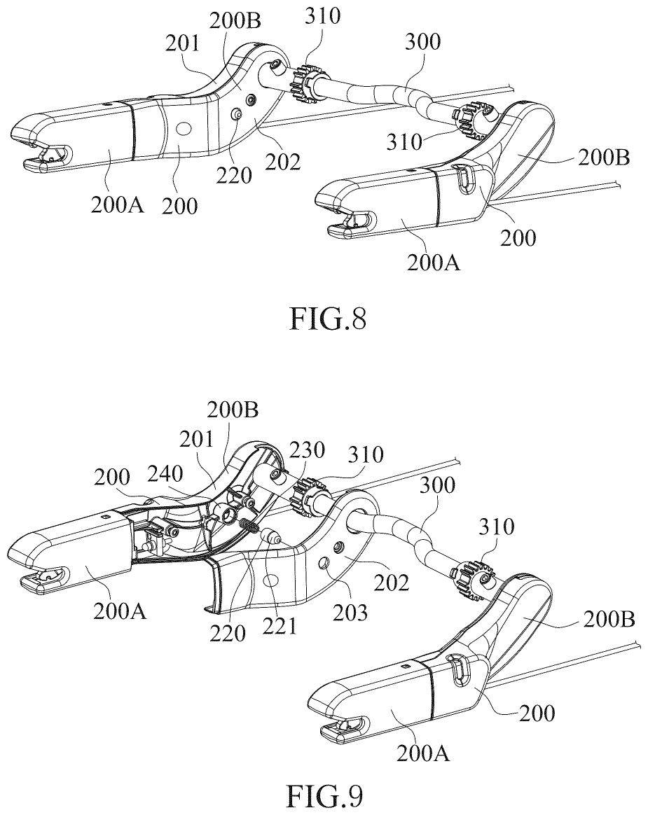

In embodiments shown in FIGS. 1 to 9, the anchor 200 is provided with an engagement portion 210, and the carrier body 100 is provided with a position limiting portion 110. When the anchor 200 is pivoted to the folded position, the engagement portion 210 may engage with the position limiting portion 110 to restrict the anchor 200 in the folded position, thereby preventing the anchor 200 from unexpectedly leaving the folded position due to its own gravity. The engagement between the engagement portion 210 and the position limiting portion 110 can ensure reliable position limitation of the anchor 200, making it less prone to loosening.

In an embodiment shown in FIG. 1, the carrier body 100 may be provided with a receiving groove 130, and the anchor 200 pivoted to the folded position may be accommodated in the receiving groove 130. The position limiting portion 110 may be provided on a side of the receiving groove 130 facing the anchor 200, and the engagement portion 210 may be provided on a side of the anchor 200 facing the receiving groove 130. Certainly, the position limiting portion 110 and the engagement portion 210 may also be provided at other positions on the carrier body 100 and the anchor 200, respectively.

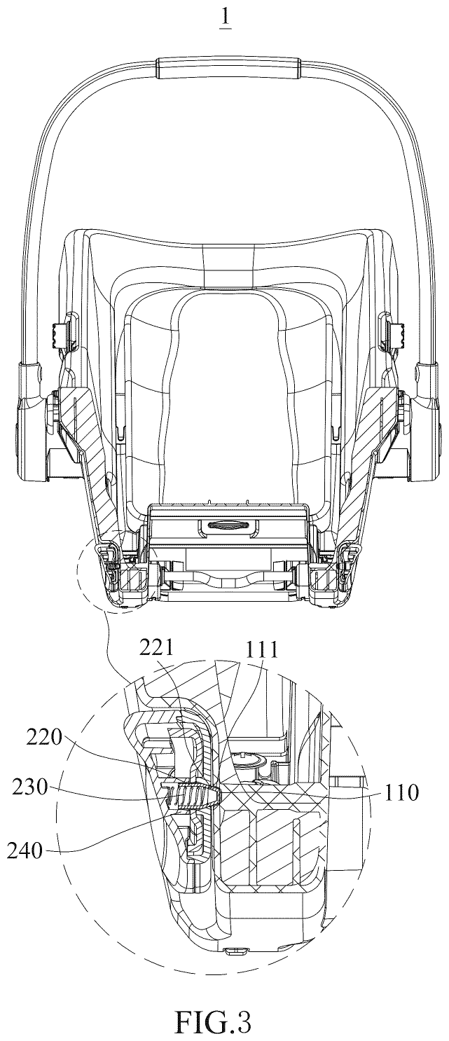

In the embodiments shown in FIGS. 1 to 9, the position limiting portion 110 may be a position limiting slot, and the engagement portion 210 may include an engagement pin 220 and an engagement spring 230. As shown in FIGS. 3, 8, and 9, the engagement pin 220 may protrude from or retract into the anchor 200, and the engagement spring 230 tends to make the engagement pin 220 protrude from the anchor 200 to engage with the position limiting slot 110 (see FIG. 3).

In an embodiment shown in FIG. 9, the anchor 200 may include an anchor outer shell 201 away from the carrier body 100 and an anchor inner shell 202 close to the carrier body 100. The anchor inner shell 202 is provided with an inner shell opening 203, and the engagement pin 220 passes through the inner shell opening 203 to protrude from or retract into the anchor 200.

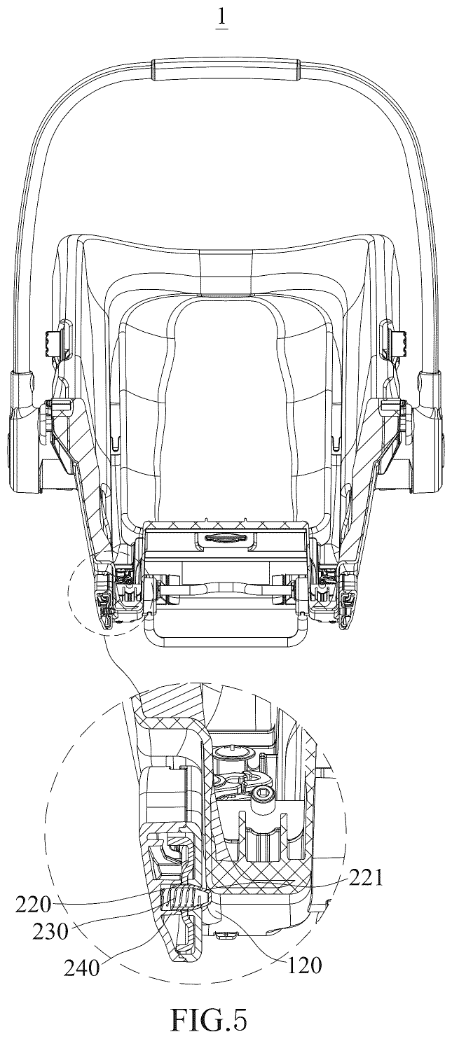

In order to ensure that the engagement pin 220 moves along a specified trajectory, a cylindrical position limiting ring 240 may be provided on an inner side wall of the anchor outer shell 201, and the engagement pin 220 is configured to move within the position limiting ring 240. Moreover, the position limiting ring 240 facilitates the installation and position limiting of the engagement spring 230. For example, in the embodiments shown in FIGS. 3 and 5, the engagement pin 220 is movably accommodated within the position limiting ring 240, and the engagement spring 230 is installed with one end abutting against an interior of the engagement pin 220 and the other end abutting against the bottom of the position limiting ring 240.

In order to facilitate the user's operation of driving the anchor 200 away from the folded position, as shown in FIG. 3, the engagement end 221 of the engagement pin 220 that engages with the position limiting slot 110 is tapered. Correspondingly, an opening edge of the position limiting slot 110 may be provided with a first guiding slope 111. The first guiding slope 111 is configured to interact with the engagement end 221 when the anchor 200 is driven by the user to leave the folded position to cause the engagement pin 220 to overcome an elastic force of the engagement spring 230 and retract into the anchor 200, thereby disengaging from the position limiting slot 110 and allowing the anchor 200 to pivot away from the folded position toward the unfolded position. This configuration makes it easy for the user to unlock the anchor.

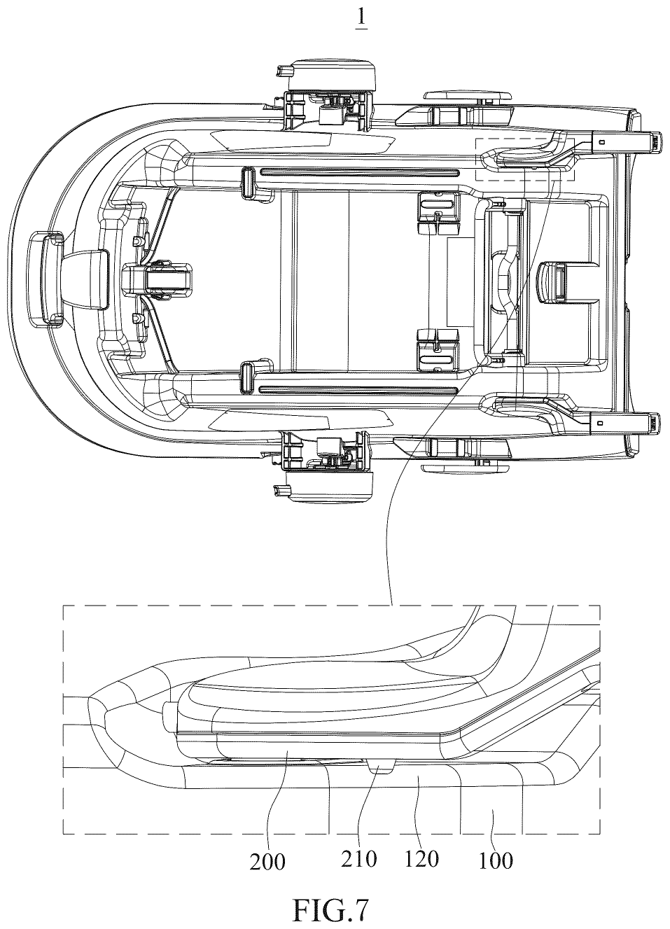

In order to facilitate the user's operation of driving the anchor 200 into the folded position, as shown in FIGS. 5 and 7, when the engagement end 221 of the engagement pin 220 is tapered, an edge of the carrier body 100 in contact with the engagement pin 220 is provided with a second guiding slope 120. The second guide slope 120 is configured to interact with the engagement end 221 when the anchor 200 is driven by the user to pivot toward the folded position to cause the engagement pin 220 to overcome the elastic force of the engagement spring 230 and retract into the anchor 200, allowing the anchor 200 to pivot to the folded position and the engagement pin 220 to engage with the position limiting slot 110, thereby restricting the anchor 200 in the folded position. This configuration makes it easy for the user to limit the position of the anchor.

By adjusting the elastic force of the engagement spring 230, the force required to drive the anchor 200 away from or into the folded position can be controlled.

As shown in FIGS. 1, 2, 4, 6, 8, and 9, the anchor 200 may include a straight anchor connecting joint 200A at its free end and a curved anchor connecting portion 200B at its pivot end. The anchor connecting joint 200A is configured to connect to the vehicle seat, and the anchor connecting portion 200B is pivotally connected to the carrier body 100 and curved toward the folded position. Certainly, the present disclosure is not limited thereto.

In the embodiment shown in FIGS. 1, 8, and 9, the engagement pin 220 is provided on the anchor connecting portion 200B, to allow the engagement pin 220 closer to a pivot axis of the anchor 200. As a result, a resistance torque generated by the engagement pin 220 and the engagement spring 230 to prevent the anchor 200 from entering or leaving the folded position is smaller, so that the user may easily drive the anchor 200 into or out of the folded position with less force. Additionally, placing the engagement pin 220 on the anchor connecting portion 200B may hide the engagement pin 220. If the engagement pin 220 is placed on or near the anchor connecting joint 200A, the protruding engagement pin 220 may scratch a leather cover of the vehicle seat when the anchor 200 engages with the anchor point on the vehicle seat. Rather, if the engagement pin 220 is provided on the anchor connecting portion 200B, the above issue can be avoided.

Furthermore, the anchor connecting portion 200B is curved toward the folded position. This can ensure that the anchor connecting joint 200A connected to the anchor connecting portion 200B, which has a relatively large weight, has a short moment arm length relative to the pivot axis of the anchor 200 when in the folded position. As a result, it can prevent the anchor 200 from accidentally unlocking due to bumps during the movement of the infant carrier 1.

In another embodiment, the engagement end 221 of the engagement pin 220 that engages with the position limiting slot 110 may not be tapered, the opening edge of the position limiting slot 110 may not be provided with the first guiding slope 111, and the edge of the carrier body 100 in contact with the engagement pin 220 may not be provided with the second guiding slope 120. Instead, an engagement pin actuator (not shown) may be provided on the anchor 200, which may be operated by the user to drive the engagement pin 220 to retract into the anchor 200.

In yet another embodiment, the position limiting portion 110 and the engagement portion 210 may adopt other cooperative structures. For example, the engagement portion 210 may be a blocking protrusion provided on the carrier body 100, and the position limiting portion 110 may be the edge of the anchor 200. When the anchor 200 is pivoted to the folded position, the blocking protrusion abuts against the edge of the anchor 200 to prevent the anchor 200 from leaving the folded position.

In another embodiment, the positions of the engagement portion 210 and the position limiting portion 110 may be exchanged. For example, the anchor 200 may be provided with the position limiting portion 110, and the carrier body 100 may be provided with the engagement portion 210. This arrangement can also achieve a technical effect of restricting the anchor 200 in the folded position.

When the user drives the anchor 200 away from the folded position, the anchor 200 may rapidly fall to the unfolded position under the gravity, to potentially cause impact or noise. To avoid such issue, the second embodiment of the present disclosure further proposes following solution.

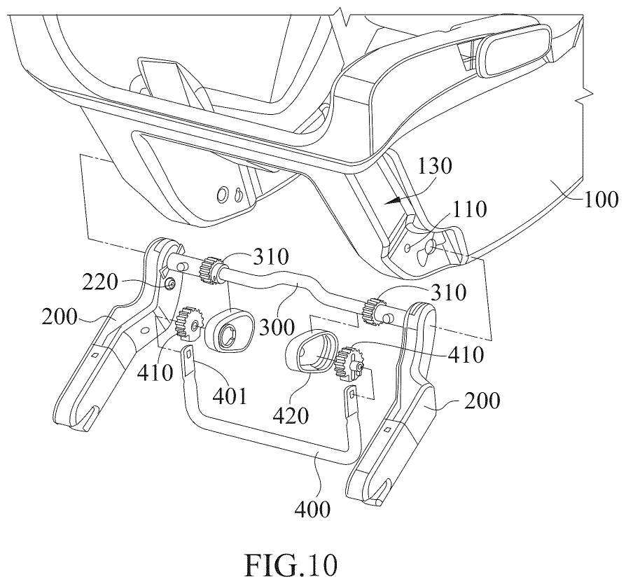

As shown in FIG. 10, the infant carrier 1 includes two anchors 200, which may be connected and synchronized via a connecting rod 300. The connecting rod 300 is provided with a connecting rod gear 310. A rotation axis of the connecting rod 300 coincides with a rotation axis of the connecting rod gear 310, allowing the anchors 200, the connecting rod 300, and the connecting rod gear 310 to rotate synchronously.

The carrier body 100 is provided with a support device. The support device includes a pivotable support rod 400 and a support rod gear 410 fixedly connected to a pivot end 401 of the support rod 400. A pivot axis of the support rod 400 coincides with a rotation axis of the support rod gear 410, allowing them to rotate synchronously.

Furthermore, the support rod gear 410 meshes with the connecting rod gear 310, to cause the pivot direction of the support rod 400 to be opposite to that of the anchor 200.

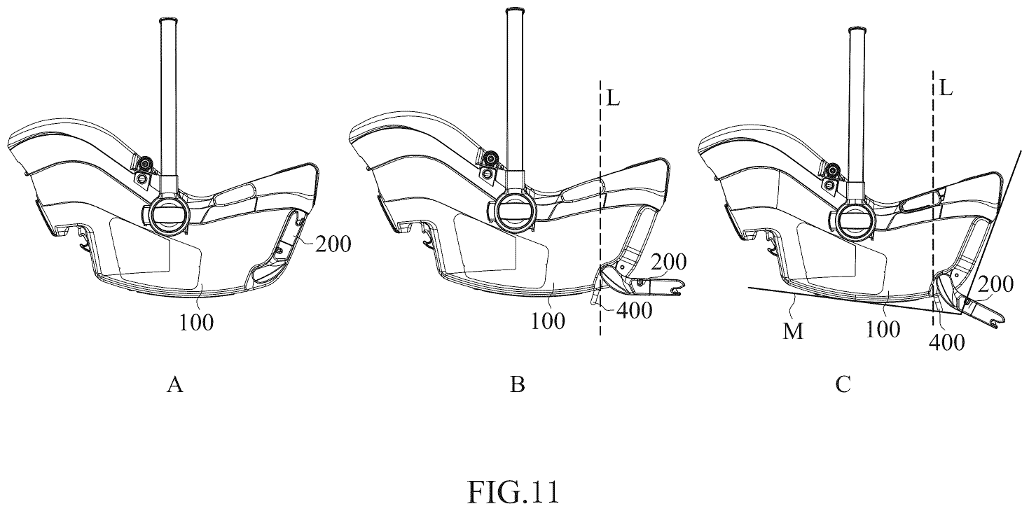

As shown in FIG. 11(A), when the anchor 200 is in the folded position, the support rod 400 is located on a left side of a vertical line L passing through the pivot axis of the support rod 400 (hereinafter referred to as “vertical line L”) (in FIG. 11(A), the support rod 400 is blocked by the carrier body 100 and thus cannot be seen).

As shown in FIG. 11(B), the anchor 200 pivots clockwise to an intermediate position along a clockwise direction as shown. Since the support rod gear 410 meshes with the connecting rod gear 310, causing the pivot direction of the support rod 400 to be opposite to that of the anchor 200, the support rod 400 pivots along a counterclockwise direction as shown. At this time, the support rod 400 is still located on the left side of the vertical line L.

As shown in FIG. 11(C), when the anchor 200 continues to pivot along the clockwise direction to the unfolded position, the support rod 400 pivots along the counterclockwise direction to a right side of the vertical line L.

When the anchor 200 is in the unfolded position, the support rod 400 is located on the right side of the vertical line L. This structure can bring about two beneficial effects below.

1. When the infant carrier 1 is fixed to the vehicle seat, the anchor 200 is pivoted to the unfolded position and engages with the anchor point on the vehicle seat. The support rod 400 is located on the right side of the vertical line L, away from the carrier body 100, and abuts against a vehicle seat surface M together with the bottom of the carrier body 100 (see FIG. 11(C)). Since the support rod gear 410 meshes with the connecting rod gear 310, when the support rod 400 abuts against the vehicle seat surface M, it can play a role of fixing the position of the anchor 200, to prevent the anchor 200 from pivoting along the counterclockwise direction toward the folded position and cause the carrier body 100 to tip over onto the backrest of the vehicle seat.

2. During a process of the anchor 200 pivoting along the clockwise direction from the position shown in FIG. 11(B) to the position shown in FIG. 11(C), since the support rod gear 410 meshes with the connecting rod gear 310, causing the pivot direction of the support rod 400 to be opposite to that of the anchor 200, the support rod 400 pivots along the counterclockwise direction from the left side to the right side of the vertical line L. After passing the vertical line L, its center of gravity is raised, which can slow down the rapid falling of the anchor 200.

In order to ensure that the support rod gear 410 is engaged with the connecting rod gear 310 in a clean environment and avoid transmission failure due to contamination by foreign objects, in the embodiment shown in FIG. 10, the support device includes a gearbox 420. The support rod gear 410 and the connecting rod gear 310 may be accommodated in the gearbox 420, and the gearbox 420 is provided on the carrier body 100. Moreover, the gearbox 420 may provide support for the support rod 400 and the support rod gear 410.

Certainly, the present disclosure is not limited thereto.

In yet another embodiment, the support device may not include the gearbox 420, and the support rod 400 and the support rod gear 410 may be connected via a rotational shaft (not shown) provided on the carrier body 100 and rotate synchronously around the pivot axis.

Additionally, when the anchor 200 is in the unfolded position, the engagement pin 220 on the anchor 200 may abut against the second guiding slope 120 to prevent the anchor 200 from pivoting toward the folded position. This can prevent the anchor 200 from shaking due to the bumps during the movement of the infant carrier 1.

What is claimed is:

1. An infant carrier, comprising:
a carrier body;
an anchor for connecting to a vehicle seat, the anchor being pivotally connected to the carrier body and configured to pivot between a folded position and an unfolded position,
wherein one of the carrier body and the anchor is provided with an engagement portion, and the other one of the carrier body and the anchor is provided with a position limiting portion, and when the anchor is pivoted to the folded position, the engagement portion is engaged with the position limiting portion to restrict the anchor in the folded position,
wherein the position limiting portion is a position limiting slot, the engagement portion includes an engagement pin and an engagement spring, the engagement pin is configured to protrude from or retract into the one of the carrier body and the anchor, and the engagement spring tends to make the engagement pin protrude from the one of the carrier body and the anchor to engage with the position limiting slot.

2. The infant carrier according to claim 1, wherein an engagement end of the engagement pin that engages with the position limiting slot is tapered, and an opening edge of the position limiting slot is provided with a first guiding slope, so that the engagement pin is disengaged from the position limiting slot when the anchor is driven to pivot.

3. The infant carrier according to claim 1, wherein the engagement end of the engagement pin that engages with the position limiting slot is tapered, and an edge of the other one of the carrier body and the anchor that contacts the engagement pin is provided with a second guiding slope, so that the engagement pin retracts into the one of the carrier body and the anchor when the anchor is driven to pivot toward the folded position.

4. The infant carrier according to claim 2, wherein the engagement end of the engagement pin that engages with the position limiting slot is tapered, and an edge of the other one of the carrier body and the anchor that contacts the engagement pin is provided with a second guiding slope, so that the engagement pin retracts into the one of the carrier body and the anchor when the anchor is driven to pivot toward the folded position.

5. The infant carrier according to claim 1, wherein the anchor includes a straight anchor connecting joint at its free end and a curved anchor connecting portion at its pivot end, the anchor connecting joint is configured to connect with the vehicle seat, and the anchor connecting portion is pivotally connected with the carrier body and curved toward the folded position,
wherein the position limiting slot or the engagement pin is provided on the anchor connecting portion.

6. The infant carrier according to claim 2, wherein the anchor includes a straight anchor connecting joint at its free end and a curved anchor connecting portion at its pivot end, the anchor connecting joint is configured to connect with the vehicle seat, and the anchor connecting portion is pivotally connected with the carrier body and curved toward the folded position,
wherein the position limiting slot or the engagement pin is provided on the anchor connecting portion.

7. The infant carrier according to claim 3, wherein the anchor includes a straight anchor connecting joint at its free end and a curved anchor connecting portion at its pivot end, the anchor connecting joint is configured to connect with the vehicle seat, and the anchor connecting portion is pivotally connected with the carrier body and curved toward the folded position,
wherein the position limiting slot or the engagement pin is provided on the anchor connecting portion.

8. The infant carrier according to claim 1, wherein the carrier body is provided with a receiving groove, and the anchor pivoted to the folded position is configured to be accommodated in the receiving groove,
wherein the position limiting slot is provided on a side of the receiving groove facing the anchor, and the engagement pin is provided on a side of the anchor facing the receiving groove.

9. The infant carrier according to claim 2, wherein the carrier body is provided with a receiving groove, and the anchor pivoted to the folded position is configured to be accommodated in the receiving groove,
wherein the position limiting slot is provided on a side of the receiving groove facing the anchor, and the engagement pin is provided on a side of the anchor facing the receiving groove.

10. The infant carrier according to claim 3, wherein the carrier body is provided with a receiving groove, and the anchor pivoted to the folded position is configured to be accommodated in the receiving groove,
wherein the position limiting slot is provided on a side of the receiving groove facing the anchor, and the engagement pin is provided on a side of the anchor facing the receiving groove.

11. The infant carrier according to claim 1, wherein the infant carrier includes two anchors, the two anchors are connected via a connecting rod, and the connecting rod is provided with a connecting rod gear,
the carrier body is provided with a support device, the support device includes a pivotable support rod and a support rod gear fixedly connected to a pivot end of the support rod,
wherein the support rod gear meshes with the connecting rod gear so that the pivot direction of the support rod is opposite to that of the anchor; when the anchor is in the folded position, the support rod is located on one side of a vertical line passing through a pivot axis of the support rod; and when the anchor is in the unfolded position, the support rod is located on the other side of the vertical line.

12. The infant carrier according to claim 2, wherein the infant carrier includes two anchors, the two anchors are connected via a connecting rod, and the connecting rod is provided with a connecting rod gear,
the carrier body is provided with a support device, the support device includes a pivotable support rod and a support rod gear fixedly connected to a pivot end of the support rod,
wherein the support rod gear meshes with the connecting rod gear so that the pivot direction of the support rod is opposite to that of the anchor; when the anchor is in the folded position, the support rod is located on one side of a vertical line passing through a pivot axis of the support rod; and when the anchor is in the unfolded position, the support rod is located on the other side of the vertical line.

13. The infant carrier according to claim 3, wherein the infant carrier includes two anchors, the two anchors are connected via a connecting rod, and the connecting rod is provided with a connecting rod gear,
the carrier body is provided with a support device, the support device includes a pivotable support rod and a support rod gear fixedly connected to a pivot end of the support rod,
wherein the support rod gear meshes with the connecting rod gear so that the pivot direction of the support rod is opposite to that of the anchor; when the anchor is in the folded position, the support rod is located on one side of a vertical line passing through a pivot axis of the support rod; and when the anchor is in the unfolded position, the support rod is located on the other side of the vertical line.

14. The infant carrier according to claim 3, wherein
the engagement pin is provided on the anchor, and the position limiting slot and the second guiding slope are provided on the carrier body;
the anchor is configured such that when the anchor is in the unfolded position, the engagement pin abuts against the second guiding slope to prevent the anchor from pivoting toward the folded position.

15. An infant carrier, comprising:
a carrier body;
an anchor for connecting to a vehicle seat, the anchor being pivotally connected to the carrier body and configured to pivot between a folded position and an unfolded position,
wherein one of the carrier body and the anchor is provided with an engagement portion, and the other one of the carrier body and the anchor is provided with a position limiting portion, and when the anchor is pivoted to the folded position, the engagement portion is engaged with the position limiting portion to restrict the anchor in the folded position,
wherein the infant carrier includes two anchors, the two anchors are connected via a connecting rod, and the connecting rod is provided with a connecting rod gear,
the carrier body is provided with a support device, the support device includes a pivotable support rod and a support rod gear fixedly connected to a pivot end of the support rod, wherein the support rod gear meshes with the connecting rod gear so that the pivot direction of the support rod is opposite to that of the anchor; when the anchor is in the folded position, the support rod is located on one side of a vertical line passing through a pivot axis of the support rod; and when the anchor is in the unfolded position, the support rod is located on the other side of the vertical line.
